(19) United States
(12) Patent Application Publication
(10) Pub. No.: US 2026/0235309 A1
(43) Pub. Date: Aug. 13, 2026

(54) MISTING FAN

(71) Applicant: Changcai HU, Huidong County (CN)

(72) Inventor: Changcai HU, Huidong County (CN)

(73) Assignee: Shenzhen Xiaohei Technology Electronics Co., Ltd., Shenzhen (CN)

(21) Appl. No.: 19/529,085

(22) Filed: Feb. 3, 2026

(30) Foreign Application Priority Data
Jan. 26, 2026 (CN) 202620106284.0

(51) Int. Cl. F24F 6/14; F04D 19/00; F04D 25/08; F04D 29/54; F24F 6/00

(52) U.S. Cl. CPC F24F 6/14; F04D 19/002; F04D 25/084; F04D 29/545; F24F 2006/008

(57) ABSTRACT

A misting fan, including: a blade assembly having an air outlet and an air inlet respectively disposed on two sides thereof; a water tank assembly having a water storage chamber disposed therein, wherein the water storage chamber surrounds an outer periphery of the blade assembly; a misting assembly located below the water tank assembly and in fluid communication with the water storage chamber; the misting assembly is configured to atomize water received from the water storage chamber and spray the atomized water into an external environment; a holding assembly connected below the misting assembly, wherein the misting assembly is configured to rotate relative to the holding assembly. The present disclosure provides a misting fan with a large water storage capacity, capable of rotating to adjust the air outlet direction and spray direction.

### CROSS-REFERENCE TO RELATED APPLICATIONS

This application claims foreign priority of Chinese Patent Application No. 202620106284.0, filed on January 26, 2026 in the China National Intellectual Property Administration, the disclosures of all of which are hereby incorporated by reference.

### TECHNICAL FIELD

The present disclosure relates to the technical field of fan, in particular to a misting fan.

### BACKGROUND

A fan is a commonly used cooling device in daily life. By simply supplying power, a fan generates airflow that facilitates the evaporation of sweat on the surface of the human body, thereby achieving a cooling effect. To improve the cooling efficiency of fans, a fan with a spraying function has been developed, which releases mist that disperses with the airflow. However, some fans are designed to have a fixed angle, which makes it impossible to adjust the airflow and misting assembly direction when the user requires localized cooling.

Currently, existing misting fans on the market have their water storage chambers located at the handle, making it difficult for users to monitor the water level of the water storage chambers. Some models have the water storage chamber partially surrounding the fan blade assembly, which can result in insufficient water storage. Furthermore, mist outlets are often located in the center of the fan blade assembly, causing the mist to be easily blown away by the airflow, reducing the effectiveness of humidification and cooling. In terms of the fan's rotational functionality, additional mechanical structures are often required, and only overall rotation is achievable. Particularly when the handheld fan is placed on a surface, due to the lack of an independent rotation adjustment mechanism, the direction of airflow cannot be reliably adjusted.

### SUMMARY

The present disclosure provides a misting fan that addresses the above-mentioned problems effectively. The structure is simple and versatile.

To realize the above objective, the present disclosure provides a misting fan, including: a blade assembly having an air outlet and an air inlet respectively disposed on two sides thereof; a water tank assembly having a water storage chamber disposed therein, wherein the water storage chamber surrounds an outer periphery of the blade assembly; a misting assembly located below the water tank assembly and in fluid communication with the water storage chamber; the misting assembly is configured to atomize water received from the water storage chamber and spray the atomized water into an external environment; a holding assembly connected below the misting assembly, wherein the misting assembly is configured to rotate relative to the holding assembly.

The beneficial effects are as follows. The water storage chamber is arranged around the outer perimeter of the fan blade assembly, making full use of the radial space of the fan blade assembly. This increases the water storage capacity of the chamber without significantly enlarging the overall size of the fan, thereby extending the operation time of the misting assembly. When the fan blade assembly is starting, external air is drawn in through the air inlet and expelled through the air outlet. The misting assembly is positioned below the water tank assembly and sprays mist that has been atomized from the water storage chamber. The mist is also further dispersed by the airflow from the fan blade assembly, making the mist more evenly and widely distributed into the surrounding environment, enhancing the cooling and humidifying effects. As the misting assembly is positioned below the water chamber, the water naturally flows toward the misting assembly due to gravity, ensuring stable water supply from the storage chamber. The gripping component is connected below the misting assembly and can rotate relative to it. This means that the fan blade assembly and the water tank assembly can rotate together with the misting assembly, allowing users to adjust the direction of the air outlet and the misting assembly according to personal needs.

### BRIEF DESCRIPTION OF DRAWINGS

In In order to better illustrate the technical solution of the present disclosure, the following will provide a brief description of the accompanying drawings used in the examples. These drawings are merely some embodiments of the present disclosure, and one skilled in the art could derive other drawings based on these without creative efforts.

FIG. 1 is a schematic structural diagram of a misting fan according to an embodiment of the present disclosure from.

FIG. 2 is another schematic structural diagram of the misting fan according to an embodiment of the present disclosure from.

FIG. 3 is an exploded view of the misting fan in FIG. 1.

FIG. 4 is an exploded view of the misting fan in FIG. 2.

FIG. 5 is a first cross-sectional view of the misting fan.

FIG. 6 is a second cross-sectional view of the misting fan.

FIG. 7 is an exploded diagram of a water tank and a misting assembly of the misting fan from one angle.

FIG. 8 is an exploded diagram of the water tank and the misting assembly of the misting fan from another angle.

FIG. 9 is an exploded diagram of a fan blade assembly of the misting fan from one angle.

FIG. 10 is an exploded diagram of the fan blade assembly of the misting fan from angle.

FIG. 11 is a side view of the misting fan in a first position.

FIG. 12 is a side view of the misting fan in a second position.

FIG. 13 is a perspective view of the misting fan.

Description of the reference numeral

100 blade assembly, 110 air duct, 111 air outlet, 112 air inlet, 121 driving component, 122 fan blade component, 123 mounting bracket, 200 water tank assembly, 210 water storage chamber, 211 water inlet, 212 water outlet, 220 sealing component, 221 first protrusion, 222 second protrusion, 231 slot, 232 guiding slope, 300 misting assembly, 310 atomization chamber, 320 atomizer, 330 misting nozzle, 340 misting housing, 341 rotation hole, 342 flow guiding wall, 400 holding assembly, 410 holding housing, 411 lanyard hole, 420 mounting component, 421 rotation shaft, 500 control assembly, 510 first control board, 520 display component, 530 second control board, 540 control button, 550 power supply, 560 charging interface.

### DETAILED DESCRIPTION OF THE EMBODIMENTS

To make the above-mentioned objects, features, and advantages of the present disclosure more apparent and readily understandable, specific embodiments of the present disclosure are described in detail below with reference to the accompanying drawings.

In the following description, numerous specific details are set forth in order to provide a thorough understanding of the present disclosure. However, the present disclosure may be embodied in many other ways different from those described herein, and persons skilled in the art may make similar modifications without departing from the spirit and scope of the present disclosure. Therefore, the present disclosure is not limited to the specific embodiments disclosed below.

In the description of the present disclosure, it is to be understood that, when terms such as “center,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counter clockwise,” “axial,” “radial,” “circumferential,” and the like appear, these terms indicate orientations or positional relationships based on the orientations or positional relationships shown in the drawings, merely for convenience in describing the present disclosure and simplifying the description, and do not indicate or imply that the referred device or element must have a particular orientation, be constructed and operated in a particular orientation, and thus should not be construed as limiting the present disclosure.

Furthermore, when terms such as “first” and “second” appear, these terms are used merely for descriptive purposes and are not to be construed as indicating or implying relative importance or implicitly specifying the number of indicated technical features. Thus, a feature defined as “first” or “second” may explicitly or implicitly include at least one such feature. In the description of the present disclosure, unless otherwise expressly and specifically limited, the term “plurality” or “a plurality of” means at least two (e.g., two, three, etc.).

In the present disclosure, unless otherwise expressly provided and limited, terms such as “mounted,” “connected,” “coupled,” “fixed,” and the like are to be understood in a broad sense. For example, the connection may be a fixed connection, a detachable connection, or an integral connection; it may be a mechanical connection or an electrical connection; it may be a direct connection or an indirect connection via an intermediate medium; it may be internal communication between two elements or an interaction relationship between two elements, unless otherwise expressly limited. For those of ordinary skill in the art, the specific meanings of the above terms in the context of the present disclosure can be understood according to specific circumstances.

In the present disclosure, unless otherwise expressly provided and limited, when a description such as a first feature being “on” or “under” a second feature appears, it may mean that the first and second features are in direct contact, or that the first and second features are in indirect contact via an intermediate medium. Moreover, the first feature being “above,” “over,” or “on top of” the second feature may mean that the first feature is directly above or obliquely above the second feature, or merely that the horizontal height of the first feature is greater than that of the second feature. Similarly, the first feature being “below,” “under,” or “beneath” the second feature may mean that the first feature is directly below or obliquely below the second feature, or merely that the horizontal height of the first feature is less than that of the second feature.

It should be noted that when an element is referred to as being “fixed to” or “disposed on” another element, it may be directly on the other element or an intervening element may also be present. When an element is referred to as being “connected to” another element, it may be directly connected to the other element or an intervening element may also be present. Where applicable, the terms “vertical,” “horizontal,” “upper,” “lower,” “left,” “right,” and similar expressions used in the present disclosure are for illustrative purposes only and are not intended to indicate that they represent the only possible implementation.

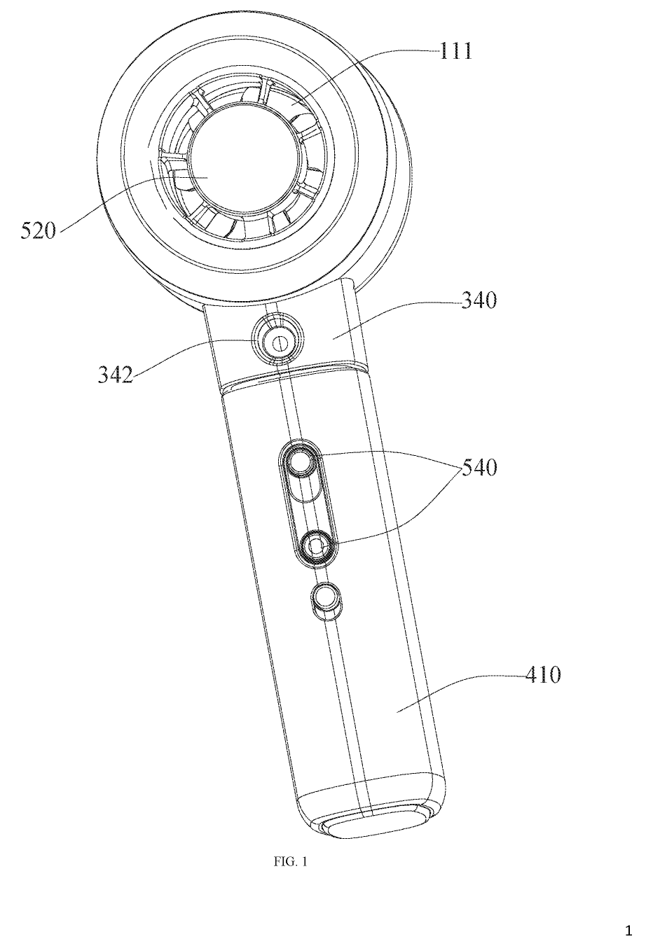

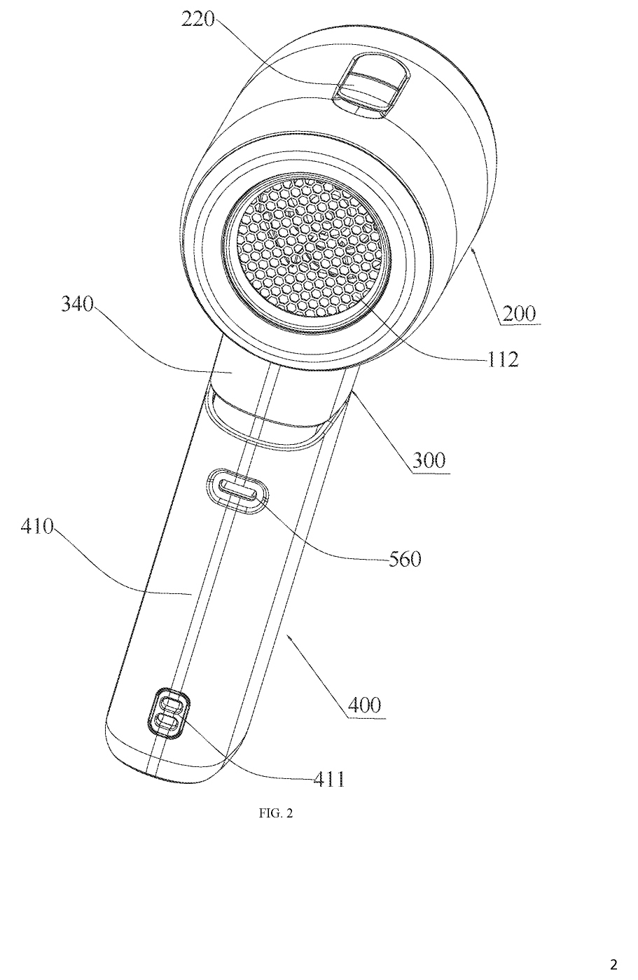

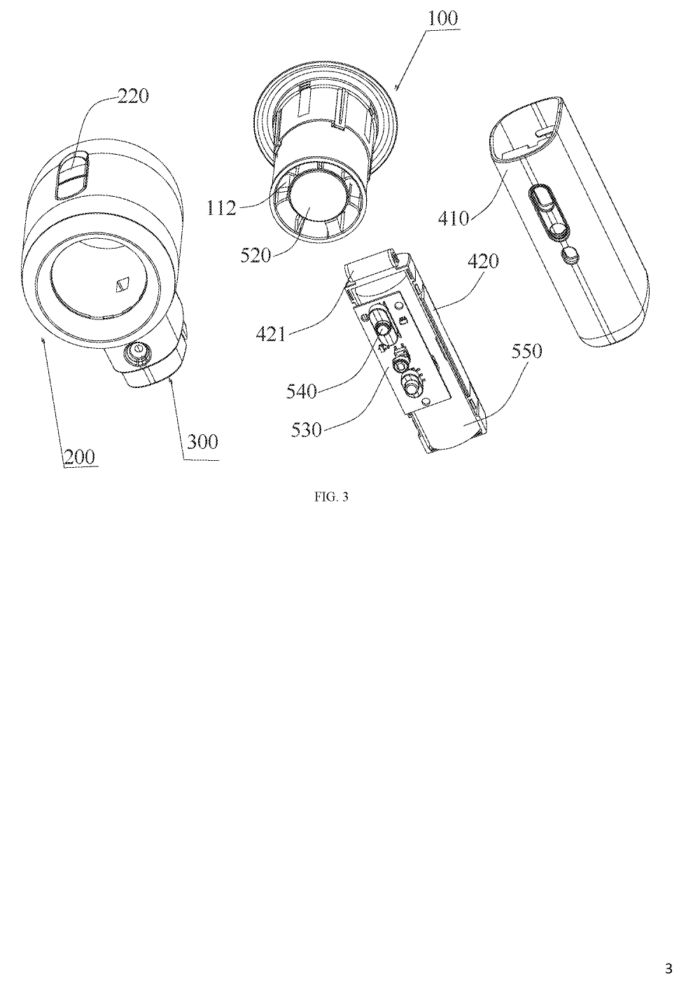

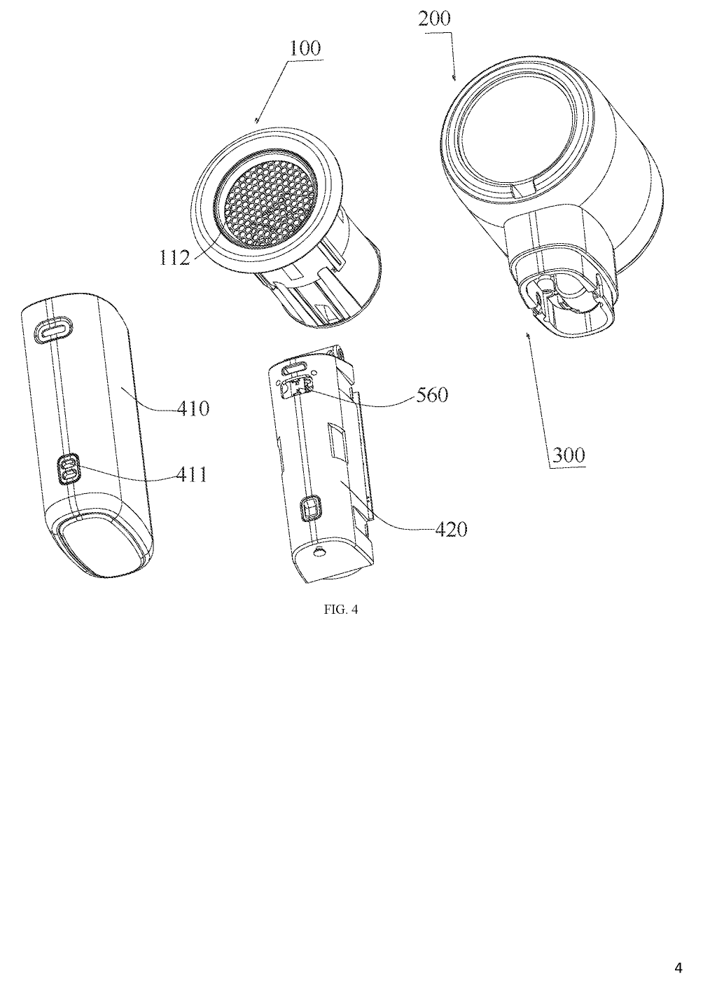

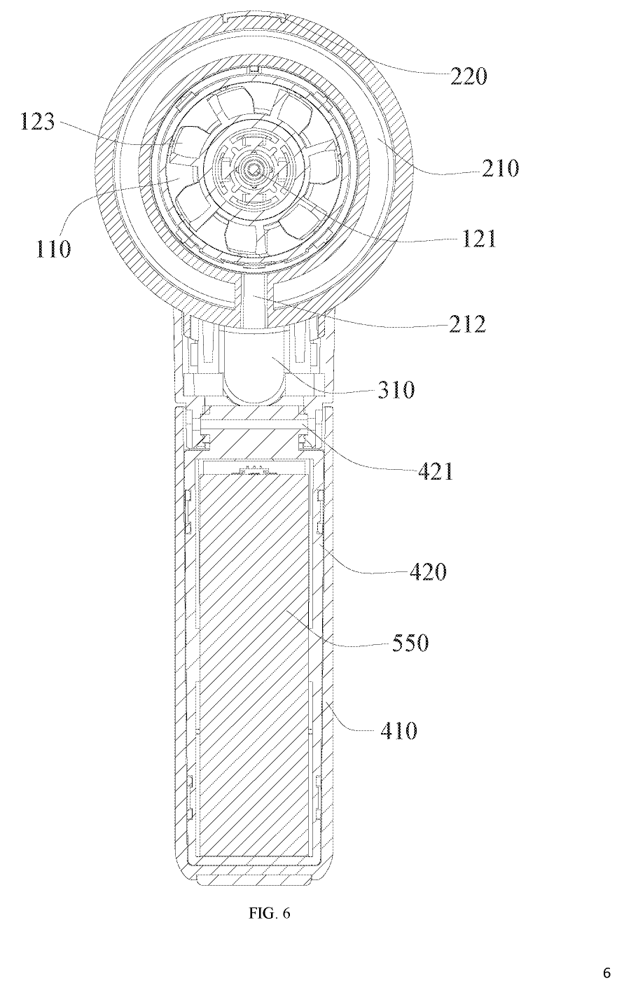

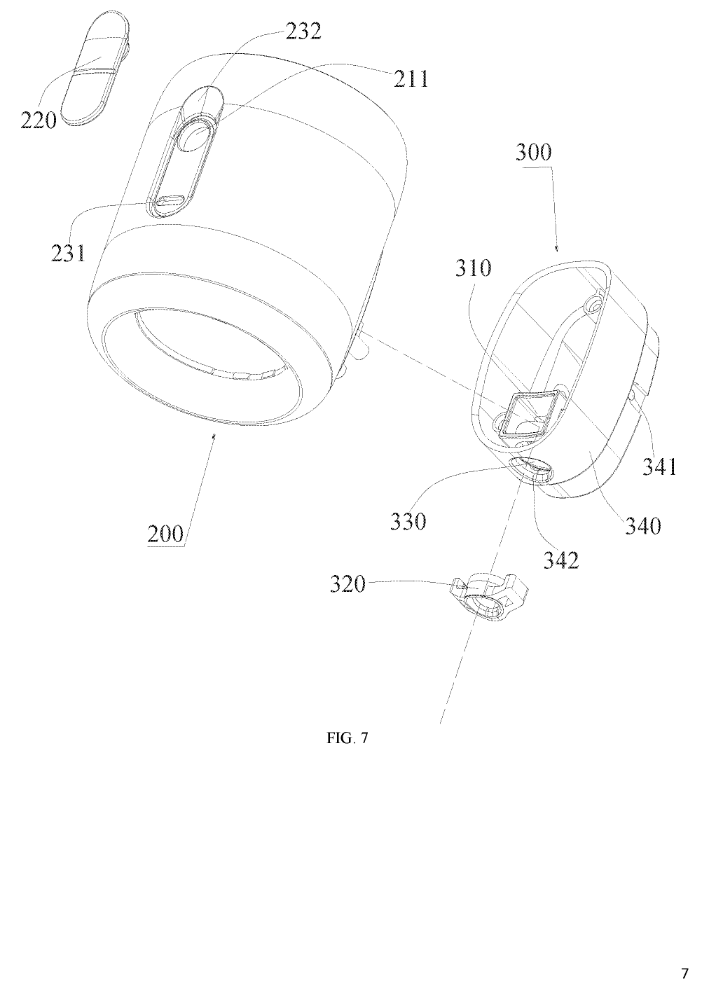

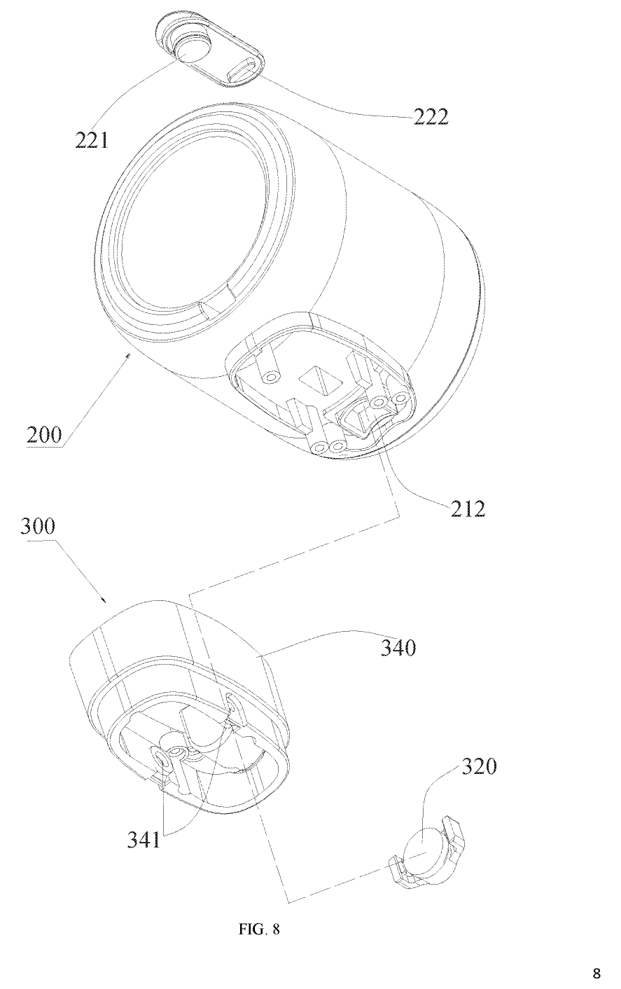

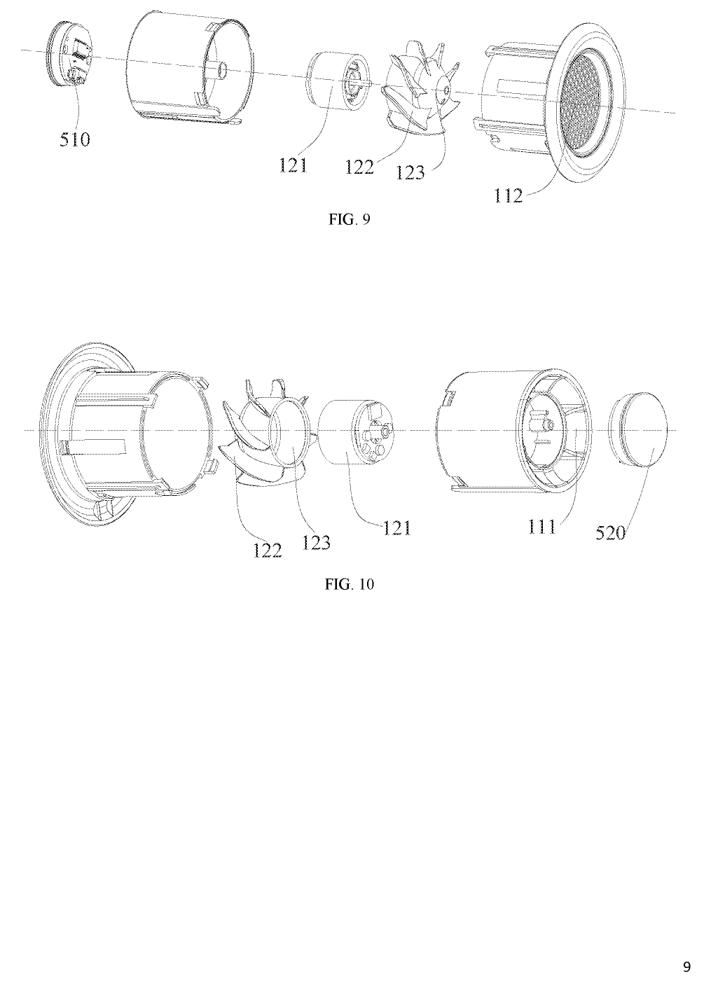

Referring to FIGS. 1 to 13, this embodiment provides a misting fan includes: a fan blade assembly 100 having an air outlet 111 and an air inlet 112 on two sides; a water tank assembly 200, where a water storage chamber 210 is provided inside the water tank assembly 200, and the water storage chamber 210 is arranged to surround an outer periphery of the fan blade assembly 100; a misting assembly 300 located below the water tank assembly 200 and in fluid communication with the water storage chamber 210, configured to atomize water received from the water storage chamber 210 and spray the atomized water to the external environment; a holding assembly 400 connected below the misting assembly 300, where the misting assembly 300 is configured to rotate relative to the holding assembly 400.

With the above structural arrangement, the water storage chamber 210 is arranged to surround the outer periphery of the fan blade assembly 100, thereby making full use of a radial space of the fan blade assembly 100. This arrangement further increases the water storage capacity of the water storage chamber 210 without significantly increasing an overall volume of the misting fan, thereby extending the operating time of the misting assembly 300. When the fan blade assembly 100 is working, external air is drawn in through the air inlet 112 and blown out through the air outlet 111. The misting assembly 300, positioned below the water tank assembly 200, atomizes water from the water storage chamber 210 and sprays atomized water outward, while the airflow generated by the fan blade assembly 100 can assist in diffusing the sprayed mist more uniformly and over a greater distance into the external environment, thereby enhancing the cooling and humidifying effect. Since the misting assembly 300 is located below the water storage chamber 210, water naturally flows toward the misting assembly 300 under the action of gravity, which is advantageous for providing stable water supply from the water storage chamber 210 to the misting assembly 300. The holding assembly 400 is connected below the misting assembly 300 and is rotatable relative thereto, allowing the fan blade assembly 100 and water tank assembly 200 to rotate together with the misting assembly 300. Thereby enabling the user to conveniently adjust directions of the air outlet 111 and the misting assembly 300 according to individual needs.

In the present embodiment, the water storage chamber 210 is annular in shape, and is provided with a water inlet 211 and a water outlet 212. The water outlet 212 is in communication with the misting assembly 300.

With this structural arrangement, the annular water storage chamber 210 surrounds the outer periphery of the fan blade assembly 100, fully utilizing a hollow region around the outer periphery of the fan blade assembly 100, thereby effectively increasing the water storage capacity of the water storage chamber 210 without significantly enlarging the overall external dimensions.

The water inlet 211 is configured to allow the user to directly replenish water into the annular water storage chamber 210 through the water inlet 211. In one embodiment, the water inlet 211 is located directly above the water tank assembly 200, and the water outlet 212 is located directly below the water tank assembly 200. Such an arrangement maximizes the water storage capacity of the water storage chamber 210. At the same time, the annular structure of the water storage chamber 210, in combination with the low-position water outlet 212, facilitates substantially complete drainage of residual water from the water storage chamber 210, thereby reducing water accumulation and residue. With the water outlet 212 positioned directly below the water storage chamber 210, water in the water storage chamber 210 can naturally flow under gravity to the misting assembly 300 located below, ensuring continuous and stable water supply to the misting assembly 300.

In this embodiment, the misting assembly 300 includes an atomization chamber 310 and a misting nozzle 330. The atomization chamber 310 is in communication with both the water outlet 212 and the misting nozzle 330, and the misting nozzle 330 is disposed on the same side as the air outlet 111.

With the above structural arrangement, the atomization chamber 310 serves as the core region for generating water mist. Water from the water storage chamber 210 enters the atomization chamber 310 directly under the action of gravity. The misting nozzle 330 is positioned on the same side as the air outlet 111 of the fan blade assembly 100, such that the water mist ejected from the misting nozzle 330 can mix with the high-velocity airflow from the air outlet 111 and rapidly diffuse into the external environment. This enables integrated output of “air + mist” simultaneously, where the synchronous and co-directional delivery of “air” and “mist” significantly improves the efficiency of cooling and humidification.

In this embodiment, the misting assembly 300 further includes an atomizer 320 disposed between the atomization chamber 310 and the misting nozzle 330.

Through the above structural configuration, the atomizer 320 (such as an ultrasonic atomization sheet, a piezoelectric ceramic atomization element, or a micro centrifugal atomization device) is arranged between the atomization chamber 310 and the misting nozzle 330. Water flowing from the water storage chamber 210 through the water outlet 212 first collects in the atomization chamber 310, is then efficiently converted into fine water mist by the atomizer 320, and is finally ejected through the misting nozzle 330, thereby forming a smooth operating path of “water storage → water supply → atomization → ejection”. The atomization chamber 310 functions as a buffer liquid storage region, which maintains continuous water coverage over the working surface of the atomizer 320, thereby preventing damage to the atomizer 320 due to instantaneous water shortage and avoiding leakage caused by excessively high-water level. Meanwhile, positioning the atomizer 320 on the outlet side of the atomization chamber 310 helps prevent airflow from flowing back into the misting assembly 300, thereby enhancing safety.

In this embodiment, a top of the holding assembly 400 is provided with a rotation shaft 421, and the misting assembly 300 further includes a misting housing 340. Both ends of the rotation shaft 421 are movably engaged into the inner wall of the misting housing 340, thereby allowing the misting assembly 300 to rotate relative to the holding assembly 400 from a first position to a second position.

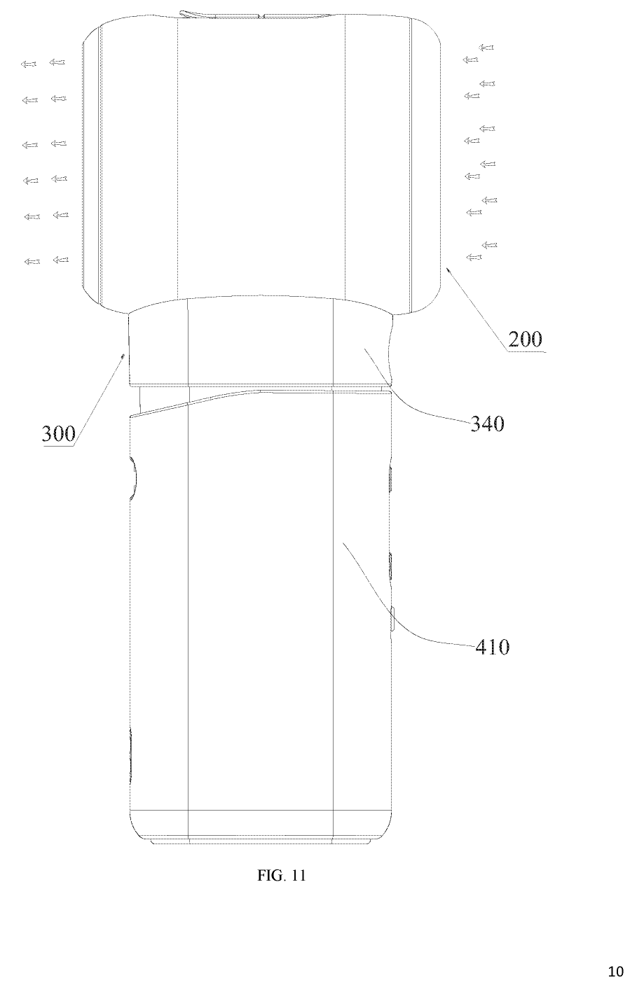

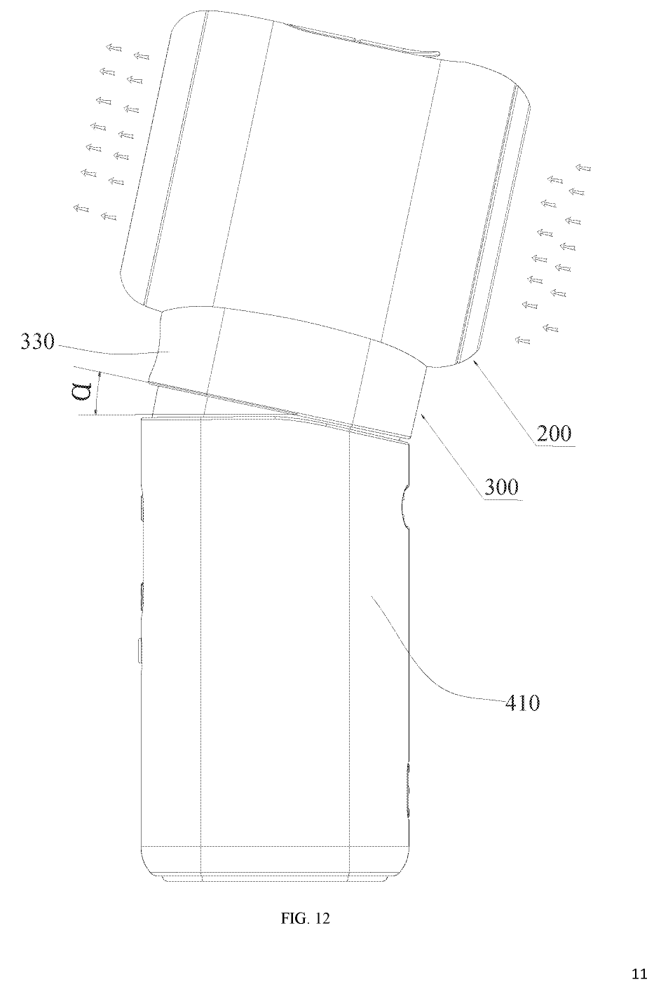

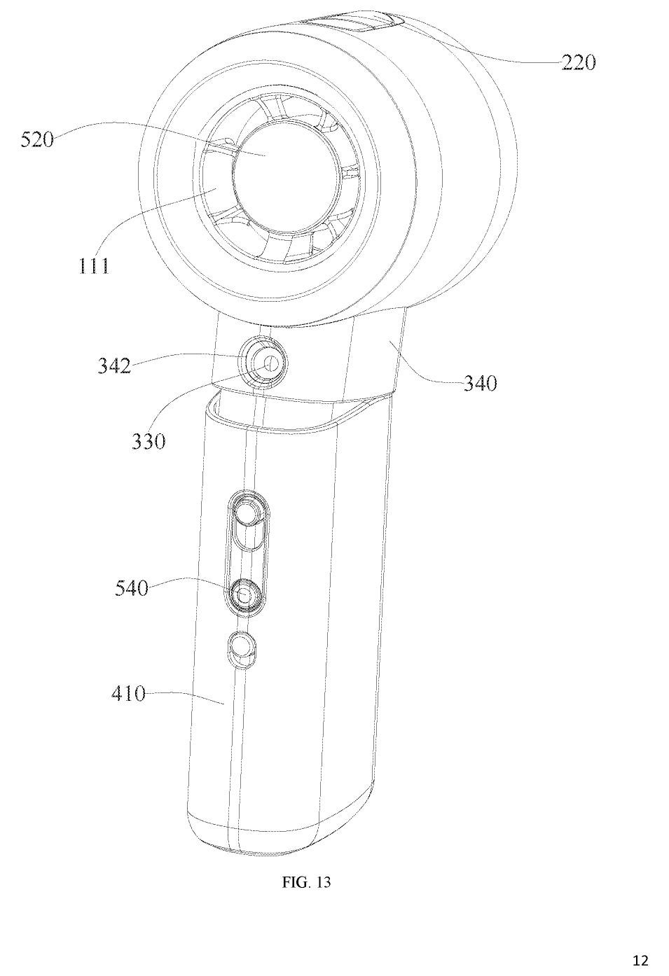

With the above structural arrangement, as shown in FIG. 11, the misting assembly 300 is in the first position relative to the holding assembly 400. As shown in FIG. 12 and FIG. 13, the misting assembly 300 is in the second position relative to the holding assembly 400. Both ends of the rotation shaft 421 are movably engaged into the inner wall of the misting housing 340, enabling the misting assembly 300 (together with the fan blade assembly 100 and the air outlet 111 located above) to be adjusted relative to the holding assembly 400 about the axis of the rotation shaft 421. The user can adjust the wind direction of the air outlet 111 and the spray direction of the misting nozzle 330 according to actual needs, for example, to direct the airflow upward toward the face or to target a specific area for humidification.

In this embodiment, the holding assembly 400 further includes a holding housing 410, where the rotation shaft 421 is located within the holding housing 410. When in the first position, a lower edge of one side of the misting housing 340 abuts against an upper edge of one side of the holding housing 410; when in the second position, a lower edge of the other side of the misting housing 340 abuts against an upper edge of the other side of the holding housing 410.

Through the above structural configuration, as illustrated in FIG. 11 to FIG. 13 (where arrows indicate the airflow direction), during rotation of the misting housing 340 about the rotation shaft 421 (i.e., from the first position to the second position), the lower edge of the misting housing 340 transitions from physical contact with the upper edge of one side of the holding housing 410 to physical contact with the upper edge of the other side of the holding housing 410, thereby forming a structure that limits excessive rotation. The rotation limiting function is achieved through mutual abutment and cooperation between the edges of the misting housing 340 and the holding housing 410, without requiring additional limiting snaps, springs, electronic angle sensors, or other components. This simplifies the internal structure of the misting fan while maintaining overall appearance integrity and smoothness. In one embodiment, as shown in FIG. 11 and FIG. 12, the maximum rotation angle α of the misting assembly 300 relative to the holding assembly 400 is less than 45°, with the optimal range of the rotation angle α being between 10° and 25°. Such rotation limitation effectively prevents internal structural damage due to excessive force applied by the user or accidental impact, and also avoids direct facing of the air outlet 111 and misting nozzle 330 toward the user's face, thereby reducing the risk of accidents.

In this embodiment, the inner wall of the misting housing 340 is provided with oppositely arranged rotation holes 341, and both ends of the rotation shaft 421 are movably engaged into the rotation holes 341.

Through the above structural arrangement, the oppositely disposed rotation holes 341 provide rotational support for the rotation shaft 421, ensuring smooth rotation of the holding assembly 400 about the axis formed by the two opposing rotation holes 341. The rotation holes 341 are directly formed in the inner wall of the misting housing 340, eliminating the need for additional bearing seats or brackets, thereby further simplifying the internal structure.

In this embodiment, the misting housing 340 is provided with a flow guiding wall 342 extending outward from an edge of the misting nozzle 330 in a peripheral direction of the misting nozzle 330.

Through the above structural configuration, the flow guiding wall 342 adopts a gradually expanding, trumpet shaped structure. The flow guiding wall 342 diffuses the water mist ejected from the misting nozzle 330, causing the originally concentrated beam-like mist flow to gradually spread outward, thereby forming a wider and more uniform spray pattern. This “magnified” spray effect can cover a larger surface area of the user's body or environmental space, improving the efficiency and comfort of cooling and humidification. At the same time, since the misting nozzle 330 is positioned proximate to the air outlet 111, the high-velocity airflow mixes with and co-diffuses the water mist. The flow guiding wall 342 cooperates synergistically with the airflow direction, not only reducing recirculation of water mist at the misting nozzle 330, but also guiding the air-mist mixture to diffuse smoothly along a predetermined direction. Thereby enhancing the effective utilization rate of the atomized water.

In this embodiment, the water tank assembly 200 further includes a sealing component 220, where the sealing component 220 is configured to cover the water inlet 211.

By virtue of the above structural arrangement, the sealing component 220 covers the water inlet 211, thereby effectively preventing water contained in the water storage chamber 210 from overflowing or leaking through the water inlet 211 during operation or movement of the misting fan. Meanwhile, in a non-working state, the sealing component 220 can significantly reduce natural evaporation of moisture from the water storage chamber 210, thereby extending the service life of a single water filling.

Furthermore, the water inlet 211 serves as the opening through which the water storage chamber 210 communicates with the external environment. In the absence of any sealing measure, dust, hair, or other foreign matter can easily enter, thereby contaminating the water source inside the water storage chamber 210, which may in turn cause clogging of the water outlet 212 or damage to the atomizer 320. The sealing component 220, functioning as a physical barrier, further ensures cleanliness and hygiene of the interior of the water storage chamber 210.

In this embodiment, a slot 231 is provided in the water tank assembly 200 at a position adjacent to the water inlet 211, and the sealing component 220 is provided with a first protrusion 221 and a second protrusion 222. The first protrusion 221 is detachably engaged into the water inlet 211, and the second protrusion 222 is detachably engaged into the slot 231.

By virtue of the above structural arrangement, the first protrusion 221 is engaged into the water inlet 211 to directly seal the outlet of the water storage chamber 210, while the second protrusion 222 is fitted into the adjacent slot 231 to form an auxiliary positioning point. The two protrusions together establish a dual-point fixation structure, which effectively prevents the sealing component 220 from lifting or detaching due to vibration, tilting, or internal water pressure variation during use, thereby ensuring stable sealing engagement between the sealing component 220 and the water inlet 211.

In one embodiment, the sealing component 220 is made of an elastic material (such as silicone or soft thermoplastic elastomer (TPE)), and the outer diameter of the first protrusion 221 is slightly larger than the inner diameter of the water inlet 211, thereby forming an interference fit that achieves tight sealing. When adding water into the water storage chamber 210, a user may remove the entire sealing component 220, or alternatively remove only the first protrusion 221 from the water inlet 211 while leaving the second protrusion 222 in place.

In this embodiment, a guiding slope 232 is provided in the water tank assembly 200 at a position adjacent to the water inlet 211.

By virtue of the above structural arrangement, during a remove process of the sealing component 220, the guiding slope 232 serves as an auxiliary force-bearing surface. A user can lightly press a fingernail or fingertip against the guiding slope 232 to contact one end of the sealing component 220, thereby facilitating easy removal of the sealing component 220 from both the water inlet 211 and the slot 231, and effectively avoiding the “difficult-to-remove” issue caused by suction force.

In this embodiment, the fan blade assembly 100 defines an air duct 110 between the air outlet 111 and the air inlet 112, and the air duct 110 is arranged coaxially with the water storage chamber 210.

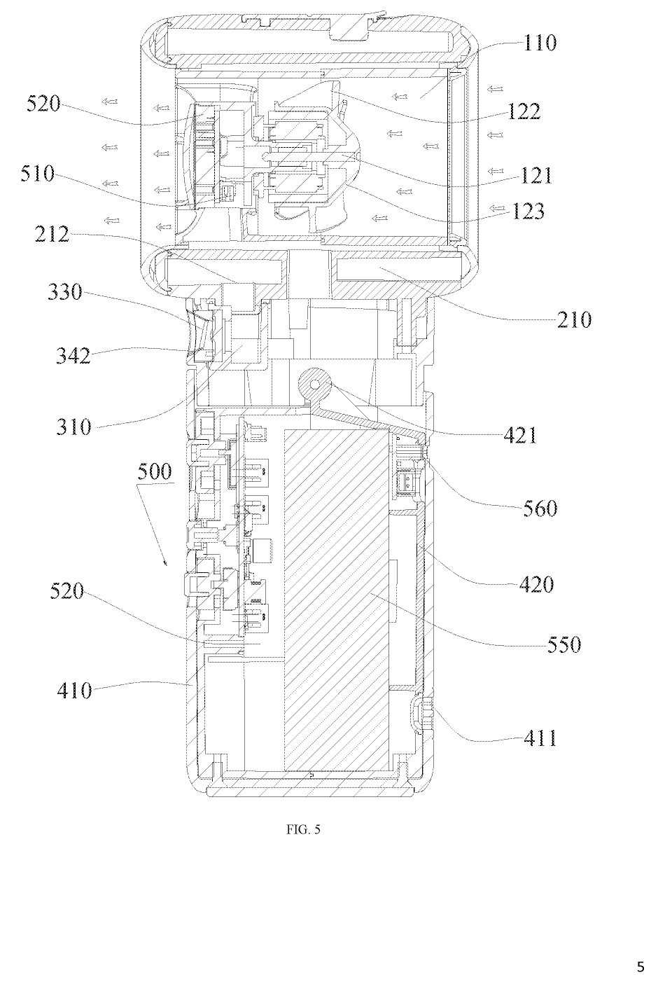

By virtue of the above structural arrangement, as shown in FIG. 5 (where arrows indicate airflow direction), the air duct 110 extends axially through the fan blade assembly 100 as an airflow passage, while the annular water storage chamber 210 is arranged to surround the air duct 110 about the same central axis, thereby forming a coaxial nested structure. This arrangement fully utilizes the radial space of the misting fan, maximizing the water storage capacity of the water storage chamber 210 while maintaining unobstructed airflow paths and without significantly increasing the overall outer diameter of the misting fan.

The annular water storage chamber 210 is symmetrically distributed around the air duct 110, such that the weight of the water tank assembly 200 is uniformly applied around the fan blade assembly 100, thereby effectively reducing center-of-gravity shift caused by changes in water level. Even when the device is used in a tilted or handheld orientation, favorable stability can still be maintained.

In this embodiment, the fan blade assembly 100 further includes a driving component 121 and fan blade component 122, wherein both the driving component 121 and the fan blade component 122 are located within the air duct 110, and an output end of the driving component 121 is connected to and drives rotation of the fan blade component 122.

By virtue of the above structural arrangement, both the driving component 121 and the fan blade component 122 are internally arranged within the air duct 110 defined by the air inlet 112 and the air outlet 111, with the fan blade component 122 being directly driven by the driving component 121. It should be noted that the fan blade assembly 100 further includes a mounting bracket 123. The fan blade component 122 is mounted on the mounting bracket 123. And an output end of the driving component 121 is directly connected to the mounting bracket 123 so as to drive rotation of the mounting bracket 123 and, in turn, synchronous rotation of the fan blade component 122.

In this embodiment, the misting fan further comprises a control assembly 500, where the control assembly 500 includes a first control board 510 and a display component 520. Both the first control board 510 and the display component 520 are disposed within the air duct 110. The display component 520 is electrically connected to the first control board 510. The display component 520 is configured to display a remaining battery level of the misting fan in real time.

By virtue of the above structural arrangement, the display component 520 (such as a light emitting diode numeric tube, organic light emitting diode screen, or liquid crystal display indicator) can intuitively and in real time display the current remaining battery level or charging status of the misting fan, thereby enabling the user to conveniently monitor the endurance capability of the misting fan. It should be noted that the first control board 510 and the display component 520 are directly integrated on the outer wall that forms the air duct 110.

In one embodiment, the display component 520 is oriented toward the air outlet 111, ensuring that the user can clearly observe a battery level of the misting fan under normal usage conditions.

Optionally, the display component 520 may also indicate the gear level of the fan blade assembly 100 (i.e., the airflow intensity). Furthermore, indicator lights or other numerical indications may be provided on the display component 520 to show whether the misting assembly 300 is activated, the gear level of the misting assembly 300 (i.e., the amount of water mist discharged from the misting nozzle 330), or to provide a low-water-level warning for the water storage chamber 210.

In this embodiment, the holding assembly 400 further includes a mounting component 420 located inside the holding housing 410, and the rotation shaft 421 is provided at a top of the mounting component 420.

By virtue of the above structural arrangement, the mounting component 420 serves as an internal structural component of the holding assembly 400 and is fixed inside the holding housing 410. The rotation shaft 421 integrated at its top end is capable of bearing the weight and rotational forces of the misting assembly 300 and the fan blade assembly 100 located thereabove, thereby avoiding insufficient strength or deformation that might occur if the rotation shaft were formed directly on the holding housing 410, and improving the operational durability of the misting fan.

In this embodiment, the control assembly 500 further includes a second control board 530 disposed on the mounting component 420 and a plurality of control buttons 540. The plurality of control buttons 540 is electrically connected to the second control board 530 so as to control starting and stopping of the fan blade assembly 100 and the misting assembly 300.

By virtue of the above structural arrangement, the plurality of control buttons is arranged at positions on the outer surface of the holding housing 410 that are easily accessible to the user, while the corresponding second control board 530 is directly disposed on the internal mounting component 420. The plurality of control buttons 540 may correspond to different functions respectively, such as “wind speed gear”, “misting intensity”, “timer shutdown”, “power on/off”, etc., and cooperate with the second control board 530 to provide the user with various adjustment options.

In this embodiment, the control assembly 500 further includes a power source 550 disposed on the mounting component 420. The power source 550 is configured to supply electrical power to the misting fan.

By virtue of the above structural arrangement, the mounting component 420, serving as the core structural component of the holding assembly 400, possesses sufficient strength, allowing the power source 550 to be securely attached thereto. This not only fully utilizes the internal space of the holding assembly 400, but also lowers the overall center of gravity of the misting fan and positions it closer to the handheld portion, thereby effectively reducing user fatigue during angle adjustment or prolonged handheld use.

In this embodiment, the control assembly 500 further includes a charging interface 560 disposed on the mounting component 420. The charging interface 560 is electrically connected to the power source 550 so as to charge the power source 550.

By virtue of the above structural arrangement, the charging interface 560 (such as micro-universal serial bus (USB), USB Type-C, or magnetic contact) is fixed to the mounting component 420 and connected to the power source 550, enabling the user to replenish electrical energy for the misting fan through the charging interface 560. It should be noted that the port of the charging interface 560 is located on the outer surface of the holding housing 410, thereby facilitating convenient insertion and removal operations by the user.

In this embodiment, at least a portion of the water tank assembly 200 is made of a transparent material. With the above structural arrangement, a user can directly observe the remaining water volume in the water storage chamber 210 through the transparent region without the need to open the water inlet 211 or disassemble the water tank assembly 200, thereby enabling timely determination of whether water replenishment is required and preventing damage to the atomizer 320 or interruption of mist output due to water shortage. Furthermore, the transparent portion allows inspection of whether scale buildup, impurity deposition, or algal growth is present in the water storage chamber 210, facilitating timely cleaning of the relevant components or replacement of the water source.

Additionally, the transparent water tank assembly 200, together with internal structures such as the fan blade assembly 100, creates a visually permeable effect, thereby enhancing the aesthetic appearance of the product.

In this embodiment, the holding housing 410 is provided with a lanyard hole 411, configured to allow a lanyard to be suspended. By virtue of the foregoing structural arrangement, a user may install a wrist strap or lanyard through the lanyard hole 411, which helps prevent slippage during handheld use, particularly in outdoor, sports, or wet-hand operating scenarios, thereby effectively reducing the risk of accidental dropping of the misting fan. Alternatively, the misting fan may be suspended from a backpack, stroller, tent, sun umbrella, or similar objects, thereby achieving hands-free operation and expanding the range of applicable usage scenarios.

In one embodiment, the lanyard hole 411 is located at a bottom corner or in a concealed side position of the holding housing 410 so as not to affect the overall external appearance. Optionally, in addition to conventional lanyards, the lanyard hole 411 may further be compatible with quick-release buckles, key rings, magnetic mounts, or other third-party accessories.

The foregoing description sets forth one or more embodiments in conjunction with specific content and should not be construed as limiting the specific implementations of the present disclosure to these illustrations. Any approaches, structures, or the like that are approximate or identical to the method and structure of the present disclosure, or any technical deductions, substitutions, or modifications made based on the inventive concept of the present disclosure, shall be deemed to fall within the protection scope of the present disclosure.

What is claimed is:

1. A misting fan, comprising:
a blade assembly having an air outlet and an air inlet respectively disposed on two sides thereof;
a water tank assembly having a water storage chamber disposed therein, wherein the water storage chamber surrounds an outer periphery of the blade assembly; and
a misting assembly located below the water tank assembly and in fluid communication with the water storage chamber; the misting assembly is configured to atomize water received from the water storage chamber and spray the atomized water into an external environment; and
a holding assembly connected below the misting assembly, wherein the misting assembly is configured to rotate relative to the holding assembly.

2. The misting fan of claim 1, wherein the water storage chamber is annular in shape and is defined with a water inlet and a water outlet, and the water outlet is in communication with the misting assembly.

3. The misting fan of claim 2, wherein the misting assembly comprises an atomization chamber and a misting nozzle, wherein the atomization chamber is in communication with both the water outlet and the misting nozzle, and the misting nozzle is arranged on the same side as the air outlet.

4. The misting fan of claim 3, wherein the misting assembly further comprises an atomizer disposed between the atomization chamber and the misting nozzle.

5. The misting fan of claim 2, wherein a top of the holding assembly is provided with a rotation shaft, and the misting assembly further comprises a misting housing; wherein both ends of the rotation shaft are movably engaged into an inner wall of the misting housing, thereby allowing the misting assembly to rotate relative to the holding assembly about the rotation shaft from a first position to a second position.

6. The misting fan of claim 5, wherein the holding assembly further comprises a holding housing, and the rotation shaft is located within the holding housing; and
wherein, when in the first position, a lower edge of one side of the misting housing abuts against an upper edge of one side of the holding housing; and
wherein, when in the second position, a lower edge of the other side of the misting housing abuts against an upper edge of the other side of the holding housing.

7. The misting fan of claim 5, wherein the inner wall of the misting housing is defined with opposing rotation holes, and both ends of the rotation shaft are movably engaged into the rotation holes.

8. The misting fan of claim 5, wherein the misting housing is provided with a flow guiding wall extending from an edge of the misting nozzle toward an outer periphery.

9. The misting fan of claim 2, wherein the water tank assembly further comprises a sealing component configured to seal the water inlet.

10. The misting fan of claim 9, wherein the water tank assembly is defined with a slot near the water inlet, and the sealing component is provided with a first protrusion and a second protrusion; wherein the first protrusion is detachably engaged into the water inlet, and the second protrusion is detachably engaged into the slot.

11. The misting fan of claim 2, wherein the water tank assembly is provided with a guiding slope near the water inlet.

12. The misting fan of claim 1, wherein an air duct is formed between the air outlet and the air inlet of the blade assembly, and the air duct is coaxially arranged with the water storage chamber.

13. The misting fan of claim 12, wherein the blade assembly further comprises a drive component and a fan blade component, wherein the drive component and the fan blade component are located inside the air duct, and an output end of the drive component is connected to the fan blade component and drives the fan blade component to rotate.

14. The misting fan of claim 12, wherein the misting fan further comprises a control assembly, which comprises a first control board and a display component; wherein the first control board and the display component are disposed inside the air duct, the display component is electrically connected to the first control board, and is configured to display a power status of the misting fan in real time.

15. The misting fan of claim 6, wherein the holding assembly further comprises a mounting component disposed inside the holding housing, and the rotation shaft is arranged at a top of the mounting component.

16. The misting fan of claim 15, wherein the control assembly further comprises a second control board disposed on the mounting component, and a plurality of control buttons; wherein the plurality of control buttons is electrically connected to the second control board to control starting and stopping of the blade assembly and the misting assembly.

17. The misting fan of claim 16, wherein the control assembly further comprises a power supply disposed on the mounting component, the power supply is configured to supply power to the first control board, the second control board, the drive component, and the atomizer.

18. The misting fan of claim 17, wherein the control assembly further comprises a charging interface disposed on the mounting component, the charging interface is electrically connected to the power supply and configured to charge the power supply.

19. The misting fan of claim 1, wherein at least a portion of the water tank assembly is made of a transparent material.

20. The misting fan of claim 6, wherein the holding housing is provided with a lanyard hole, configured to allow a lanyard to be suspended.
